(19) United States
(12) Patent Application Publication
(10) Pub. No.: US 2017/0168867 A1
(43) Pub. Date: Jun. 15, 2017

(54) INFORMATION PROCESSING SYSTEM AND CONTROL METHOD

(71) Applicant: CANON KABUSHIKI KAISHA, Tokyo (JP)

(72) Inventor: Shunsuke Ota, Kawasaki-shi (JP)

(21) Appl. No.: 15/375,658

(22) Filed: Dec. 12, 2016

(30) Foreign Application Priority Data
Dec. 15, 2015 (JP) 2015-244645

(51) Int. Cl. G06F 9/455; G06F 9/54

(52) U.S. Cl. CPC G06F 9/45558; G06F 9/546; G06F 2009/45591; G06F 2009/4557

(57) ABSTRACT

One or more virtual machines included in an information processing system each issues, if a status indicating a processing error associated with identification information of a message obtained from a queue storing a plurality of messages is stored in a storage, the identification information being included in the message, an instruction to delete the message from the queue before completion of processing of data specified by contents of the message.

### BACKGROUND OF THE INVENTION

Field of the Invention

The present disclosure relates to an information processing system and a control method for data processing using a message queue.

Description of the Related Art

As services in which various applications running on servers on the Internet can be used, there have been cloud services in recent years. In cloud services such as Infrastructure as a Service (IaaS) and Platform as a Service (PaaS), cloud service vendors provide system administrators with resources such as virtual machines and storages via a network. Virtual machines are logical computers which are constituted by dividing a server or servers into logical units by virtualization techniques regardless of physical configurations, the divided units operating with respective independent operating systems. A system administrator can use resources such as virtual machines and storages provided by cloud service vendors to construct a system for providing a specific service.

A system constructed by using cloud services may use a message queue (hereinafter, referred to as a queue) to process data in parallel. The queue stores messages corresponding to pieces of data to be processed. A virtual machine having a function of processing a message obtains a message stored in the queue and executes processing according to processing contents described in the message. A plurality of virtual machines can process messages obtained from the queue to perform parallel data processing.

In the system constructed by using the foregoing cloud services, a plurality of pieces of data generated in a specific period may be processed and aggregated into a file. In such a case, the respective messages corresponding to the plurality of pieces of data are stored in the queue, and a plurality of virtual machines processes the series of messages in parallel. In processing such a series of messages, the processing of all the corresponding messages may need to be successful. The reason is that if an error occurs in the processing of any of the messages, erroneous data or missing of data occurs in the generated file.

Japanese Patent Application Laid-Open No. 2015-60285 discusses a method for implementing one global transaction in database update processing on a plurality of databases. Specifically, update requests to the databases are stored as queue elements in a processing queue. The database update requests stored in the processing queue are then processed in succession. If the processing of any of the database update requests is failed, the results of the entire update processing including successful update processing are cancelled.

In the foregoing processing of a series of messages, all the messages are to be successfully processed. If the processing of any message in the series of messages is failed, the failure is handled as a processing error of the series of messages and thus the rest of the messages no longer need to be processed. That is, to process the rest of the series of messages is a waste of resources.

To delete the remaining unprocessed messages in the series of messages, all the messages stored in the queue may be deleted. However, since the series of messages and other messages can be stored in the same queue in a mixed manner, the other messages are also deleted if the messages stored in the queue are all deleted.

### SUMMARY OF THE INVENTION

The present disclosure is directed to a mechanism for, if processing of a message is failed, deleting messages that are stored in the queue and associated with the message from the queue before completion of processing of the messages.

According to an aspect of the present disclosure, a system includes one or more virtual machines configured to obtain a message to be processed from a queue storing the message and execute processing based on the obtained message, and a storage into which a virtual machine is capable of storing data, wherein the one or more virtual machines each include an acquisition unit configured to obtain a message from the queue, an execution unit configured to execute processing of data specified by contents of the obtained message, a storage unit configured to, if the processing executed by the execution unit is failed, store a status indicating a processing error into the storage in association with identification information of the obtained message, and an instruction unit configured to issue an instruction to delete the obtained message from the queue, and wherein the instruction unit is configured to, if the status associated with the identification information of the obtained message is stored in the storage, issue the instruction to delete the message from the queue before completion of the processing regarding the message.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration example according to an exemplary embodiment.

FIG. 2 is a block diagram illustrating a hardware configuration example of an information processing apparatus.

FIG. 3 is a block diagram illustrating an example of software functions of an information processing system.

FIG. 4 is a diagram illustrating an example of a message.

FIG. 5 is a flowchart illustrating an example of a flow of processing performed by an instruction server.

FIGS. 6A and 6B are flowcharts each illustrating an example of a flow of processing performed by a processing server.

FIG. 7 is a diagram illustrating an example of a message according to a second exemplary embodiment.

FIG. 8 is a flowchart illustrating an example of a flow of processing by an instruction server according to the second exemplary embodiment.

FIGS. 9A and 9B are flowcharts each illustrating an example of a flow of processing by a processing server according to the second exemplary embodiment.

### DESCRIPTION OF THE EMBODIMENTS

Exemplary embodiments for carrying out the present disclosure will be described below with reference to the drawings.

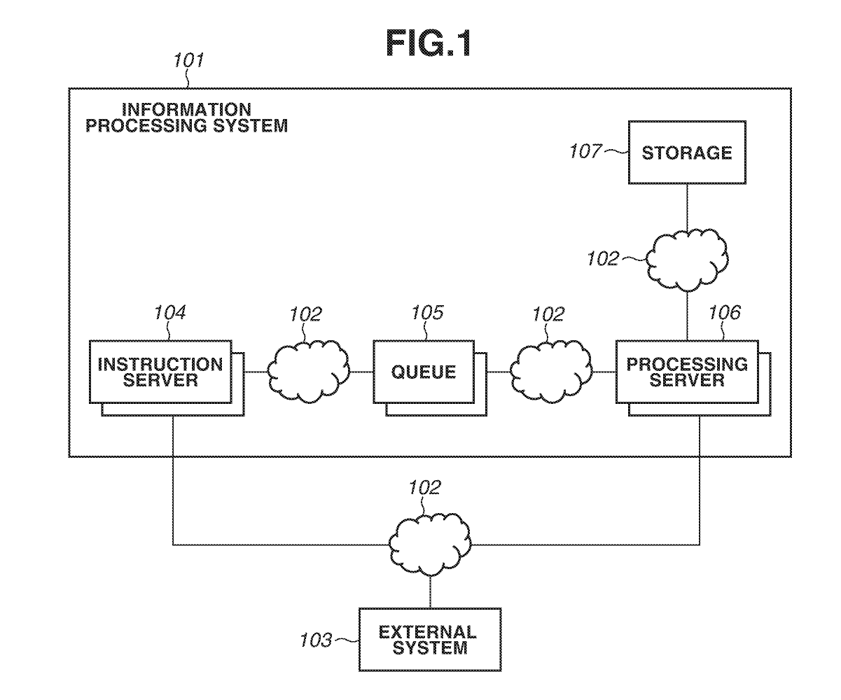

A first exemplary embodiment will be described below. FIG. 1 is a diagram illustrating a system configuration example according to an exemplary embodiment of the present disclosure.

The present system includes an information processing system 101 and an external system 103 that are connected via the Internet 102. The information processing system 101 includes instruction servers 104, queues 105, processing servers 106, and a storage 107 which are connected via the Internet 102. The present exemplary embodiment describes an example in which data obtained from the external system 103 is processed and processing results are stored in the storage 107. However, the data to be processed may be stored in the storage 107 in advance. In such a case, the storage 107 substitutes for the source from which the data is obtained.

The instruction servers 104 are virtual machines each having a function of storing messages to be processed by the processing servers 106 into the queues 105. As employed herein, virtual machines are logical computers that are constituted by dividing a server or servers into logical units by virtualization techniques regardless of physical configurations, the divided units operating with respective independent operating systems. The instruction servers 104 may be activated for only a certain time according to a set schedule, or always on.

The processing servers 106 are one or more virtual machines having a function of obtaining a message from the queues 105 and executing processing based on the obtained message. The amount of resources is automatically adjusted based on the number of messages stored in the queues 105, whereby processing servers 106 are added or deleted. Contents of adjustments to the processing servers 106 and conditions for making the adjustments are set by a system administrator in advance.

Specifically, the adjustments to the amount of resources refer to scale-out for increasing the number of virtual machines and scale-in for reducing the number of virtual machines. The adjustments of the amount of resources may include scale-up for increasing the allocation of hardware resources to a virtual machine or machines and scale-down for reducing the allocation of hardware resources to a virtual machine or machines. The hardware resources include central processing units (CPUs), memories, and storages.

Specific details of processing of the processing servers 106 may include format conversion processing on data to be processed, and compression or decompression processing on data. The servers 104 and 106 and the queues 105 communicate with each other according to protocols such as the Hypertext Transfer Protocol (HTTP), HTTP Secure (HTTPS), and Simple Object Access Protocol (SOAP).

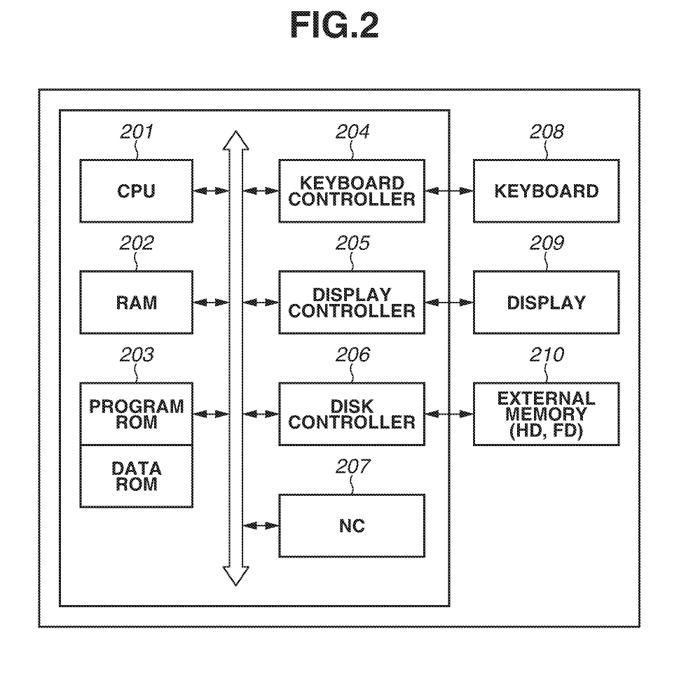

FIG. 2 is a diagram illustrating a configuration example of hardware of an information processing apparatus. In the present exemplary embodiment, information processing apparatuses include server computers residing on a data center for constructing the information processing system 101, and a computer having the functions of the external system 103.

A CPU 201 executes a program stored in a program read-only memory (ROM) in a ROM 203, and programs loaded from an external memory 202 into a random access memory (RAM) 202, such as an operating system (OS) and an application. By executing the programs stored in the readable storage media, the CPU 201 functions as processing units that perform the processing of flowcharts to be described below. The RAM 202 is a main memory of the CPU 201 and functions as a work area.

A keyboard controller 204 controls operation inputs from a keyboard 208 and a not-illustrated pointing device (such as a mouse, a touch pad, a touch panel, and a trackball). A display controller 205 controls display of a display 209. A disk controller 206 controls data access to an external memory 210 storing various types of data. Examples of the external memory 210 include a hard disk (HD) and a flexible disk (FD). A network controller (NC) 207 is connected to a network and performs communication control processing with other devices connected to the network.

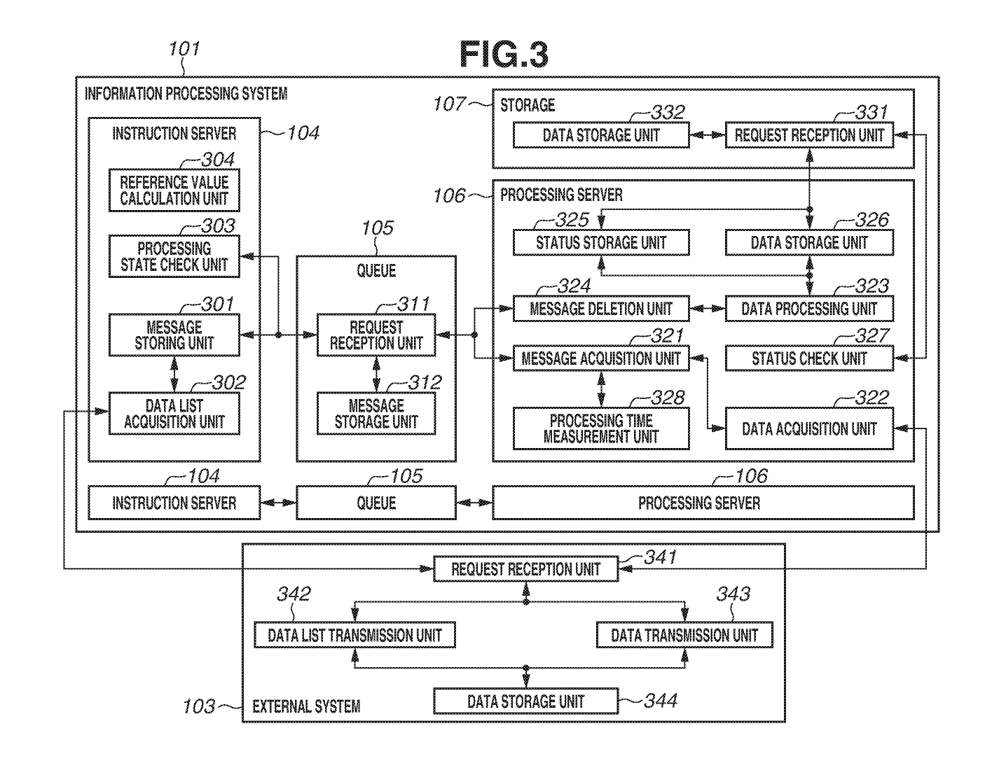

FIG. 3 is a functional block diagram illustrating functions of the information processing system 101 according to the first exemplary embodiment and a second exemplary embodiment. A reference value calculation unit 304 and a processing time measurement unit 328 are processing units according to the second exemplary embodiment. A description thereof will thus be omitted in the present exemplary embodiment.

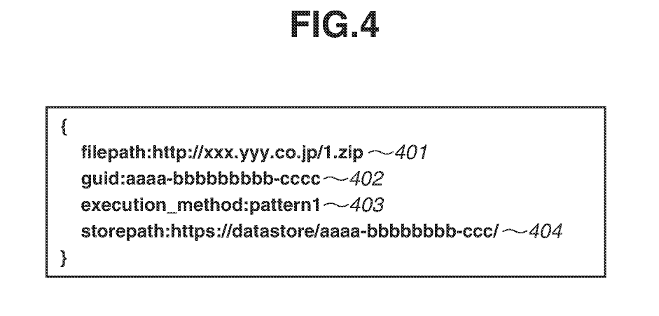

The instruction servers 104 will initially be described. The instruction servers 104 store messages for data processing into the queues 105. Examples of the data processing include the format conversion processing of data. A data list acquisition unit 302 issues a request to the external system 103 and obtains a list of data to be processed. A message storing unit 301 transmits each piece of data included in the list obtained by the data list acquisition unit 302 to a request reception unit 311 of a queue 105 as a message. Contents of a message will be described below with reference to FIG. 4. A processing state check unit 303 checks whether a message stored in the queue 105 exists in the storage 107 to be described below. If not, the processing state check unit 303 checks whether a status indicating an processing error exists in the storage 107 to be described below. If there is such a status, the processing state check unit 303 determines that processing of a series of messages is failed.

A message stored in a queue 105 will not be deleted from the queue 105 only by acquisition of the message from the queue 105. The message obtained from the queue 105 is temporarily brought into a hidden state to not be obtained by the other processing servers 106. Typically, an instruction to delete the message is then issued to the queue 105 after the processing of the message by the processing server 106 is completed. If the instruction to delete the message is not issued to the queue 105 for a certain time after the processing server 106 obtains the message from the queue 105, the hidden state of the message is cancelled and the message becomes obtainable by any of the processing servers 106.

Next, the queues 105 will be described. A request reception unit 311 receives and executes a request about a message stored in the queue 105. For example, if the request reception unit 311 receives a request issued from the message storing unit 301, the request reception unit 311 stores the message into a message storage unit 312. If the request reception unit 311 receives a request about acquisition of a message from a message acquisition unit 321 to be described below, the request reception unit 311 returns the message stored in the message storage unit 312. If the request reception unit 311 receives a request about deletion of a message from a message deletion unit 324 to be described below, the request reception unit 311 deletes the specified message. The message storage unit 312 stores the received message into a persistent medium such as a file and a database.

The processing servers 106 will be described. A message acquisition unit 321 obtains a message from a queue 105. A data acquisition unit 322 obtains data from a data acquisition source described in the message obtained by the message acquisition unit 321. A data processing unit 323 performs some kind of processing on the obtained data, and stores the processed data into the storage 107 via a data storage unit 326. If the processing of the data processing unit 323 fails, a status storage unit 325 stores a status indicating the processing error into the storage 107 in association with identification information of the message. Examples of a processing failure include a case where the format conversion processing of a file fails in conversion due to an abnormal format, and a case where an error occurs in storing a file. At this point, the identification information of the message, included in the message illustrated in FIG. 4 to be described below, is included into the path of the storage destination. A status check unit 327 checks whether there is a status stored by the status storage unit 325, before the processing by the data processing unit 323. If the check result shows that there is the status, i.e., the processing is failed, the processing proceeds to that of the message deletion unit 324 without the processing of the data specified by the message being performed.

There may be a plurality of sets of instruction servers 104, queues 105, and processing servers 106. For example, sets of instruction servers 104, queues 105, and processing servers 106 intended for respective services are prepared for each external system 103 serving as a data acquisition source. The processing servers 106 have functions capable of executing processing of any of the services.

The storage 107 will be described. A request reception unit 331 receives requests from the data storage unit 326, the status storage unit 325, and the status check unit 327, stores data, and checks the presence or absence of data. Actual data is stored in a data storage unit 322. The data storage unit 332 is constituted by a file system or a persistent medium such as a database.

Finally, the external system 103 will be described. A request reception unit 341 receives a request from the information processing system 101, and returns a list of data and data via a data list transmission unit 324 and a data transmission unit 343. Actual data is stored in a data storage unit 344. The data storage unit 344 is constituted by a file system or a persistent medium such as a database. In the present exemplary embodiment, the data to be processed is obtained from the storage destination of the data described in the message. However, the data to be processed may be included in the message.

Next, an example of a message stored in a queue 105 will be described with reference to FIG. 4. As illustrated in FIG. 4, a message includes four items. A filepath 401 describes the path where data is stored. A guid 402 describes a key representing a series of pieces of data. The key is an identifier assigned to a series of mutually-associated messages. If processing is failed, all the massages having the same guid 402 corresponding to the failed data are to be deleted. Different identifiers may be assigned to respective messages, and the identifiers of the messages in the series of messages may be managed by the storage 107. A processing pattern 403 indicates a pattern of processing to be performed on the obtained data. A storepath 404 describes the path where the processed data is stored. The filepath 401 is set by using the list of data obtained from the external system 103 by the data list acquisition unit 302. The guid 402 is dynamically issued by the data list acquisition unit 302 when the list of data to be processed is obtained. Pieces of data that are to be processed by different data processing methods may exist in a queue 105. The processing pattern 403 is used to notify the processing server 106 of an identifier (ID) for identifying the processing to be applied. The data processing unit 323 of the processing server 106 changes processing according to the processing pattern 403. The data storage unit 326 transmits the processed data to the path described in the storepath 404 to complete storing the data into the storage 107.

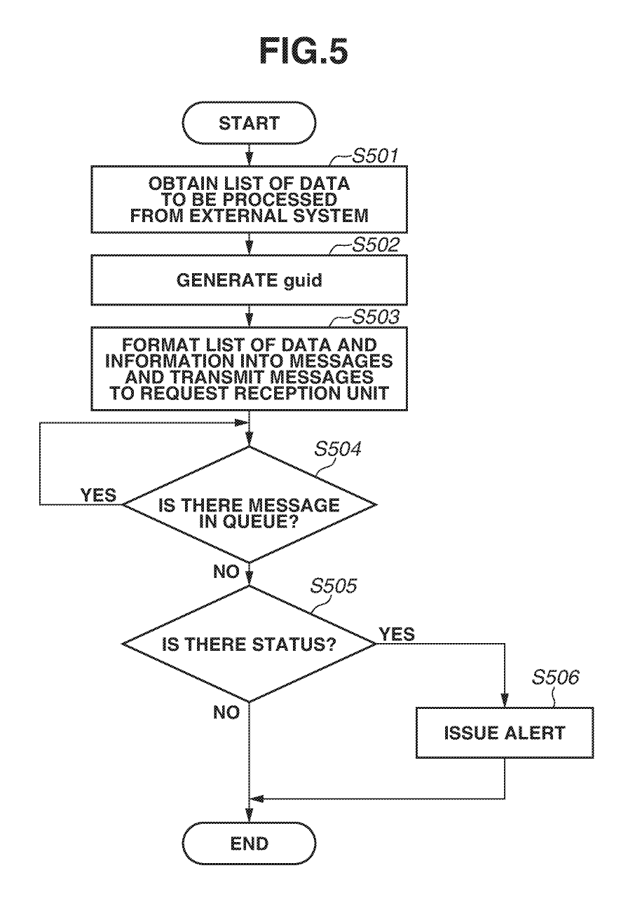

A flow of processing by the instruction server 104 will be described below with reference to FIG. 5.

In step S501, the data list acquisition unit 302 obtains a list of data to be processed from the external system 103.

In step S502, the message storing unit 301 generates the guid 402 described in FIG. 4.

In step S503, the message storing unit 301 formats the pieces of data in the list of data obtained in step S501, and information such as the guid 402 generated in step S502, the storage destination of the data, and the processing pattern into messages such as described in FIG. 4. The message storing unit 301 transmits the messages to the request reception unit 311.

In step S504, the processing state check unit 303 checks whether there is a message in the queue 105. If there is a message (YES in step S504), the processing in step S504 is repeated. If there is no message (NO in step S504), on the other hand, the processing proceeds to S504.

In step S505, the processing state check unit 303 checks whether there is a status stored in the storage 107. If there is a status (YES in step S505), the processing proceeds to step S506. If there is no status (NO in step S505), the processing is terminated.

In step S506, the processing state check unit 303 issues an alert representing a processing failure, and the processing ends. The alert may be issued by any means, such as a mail and a log.

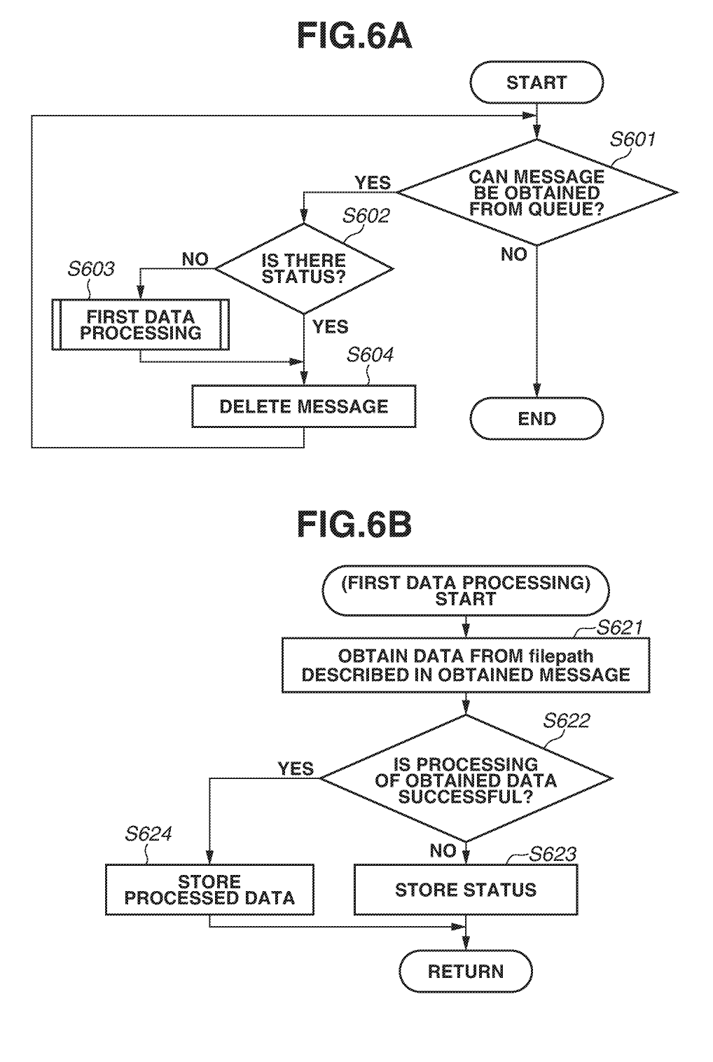

Next, a flow of processing performed by the processing server 106 will be described with reference to FIGS. 6A and 6B.

In step S601, the message acquisition unit 321 obtains a message from the queue 105. If no message can be obtained (NO in step S601), the message acquisition unit 321 considers that all messages registered by the instruction server 104 have been processed, and the processing is terminated. If a message can be obtained (YES in step S601), the processing proceeds to step S602.

In step S602, the status check unit 327 checks whether a status associated with the guid 402 included in the message is stored in the storage 107. If there is no such status (NO in step S602), the processing is determined to not be failed and proceeds to step S603. If there is the status (YES in step S602), the processing proceeds to step S604.

In step S603, data processing (first data processing) is performed. Details will be described in FIG. 6B.

In step S604, the message deletion unit 324 issues an instruction to delete the processing-completed message from the queue 105.

Next, a flow related to the data processing (first data processing) will be described.

In step S621, the data acquisition unit 322 obtains data from the filepath 404 described in the message obtained in step S601.

In step S622, the data processing unit 322 performs processing according to the processing pattern described in the message obtained in step S601, on the data obtained in step S621. If an error occurs during the processing (NO in step S622), the processing proceeds to step S623. If the processing is successful (YES in step S622), the processing proceeds to step S624.

In step S623, the status storage unit 325 stores the status in the storage 107. Here, the guid 402 included in the message is included into the file path.

In step S624, the processed data is stored into the storage 107.

By performing processing according to the flow illustrated in FIGS. 6A and 6B, the processing servers 106 can delete the messages from the queue 105 in parallel in the event of a processing failure. If there are no more messages in the queue 105, the processing servers 106 automatically scale in.

As described above, in the present exemplary embodiment, if the processing of a message is failed, the status indicating a processing error is stored in the storage 107 in association with the identification information of the message. Messages associated with this message are deleted in the subsequent processing of the messages before the processing is completed. The virtual machines can thereby quickly process other messages stored in the queue 105, which leads to effective use of resources. In a cloud service, the use fee of the resources is typically charged based on the use time thereof. The effective use of the resources and the resulting scale-in described above therefore may lead to saving of the use fee of the cloud service.

### (Application of First Exemplary Embodiment)

If there is the above-described status in the storage 107, the instruction server 104 or any one of the processing servers 106 may selectively delete the series of a plurality of messages corresponding to the status, among a plurality of messages stored in the queue 105. In such a case, the instruction server 104 may periodically check whether there is the status in the storage 107. The processing server 106 may check the presence of the status when obtaining one message from the queue 105.

A second exemplary embodiment according to the present disclosure will be described. Differences in configuration from the first exemplary embodiment will be mainly described below.

In typical cloud services, resources such as virtual machines are occupied by specific cloud service users based on a unit time related to the use of the resources. The amount of usage-based charges for the use of the resources is also determined based on the unit time. For example, if the unit time is one hour, a use fee for one hour is charged in both of a case where the use time is one minute and a case where the use time is 59 minutes. In the present exemplary embodiment, the time elapsed after virtual machines are added is managed and the processing of the virtual machines is switched based on the elapsed time if the processing of a message is failed. This enables effective use of the resources.

Software functions of the system according to the present exemplary embodiment will be described. As illustrated in FIG. 3, the instruction servers 104 further include the reference value calculation unit 304. The processing servers 106 further include the processing time measurement unit 328. Each processing server 106 uses the processing time measurement unit 328 to manage the elapsed time after its own activation. The reference value calculation unit 304 determines a reference value in consideration of the number of pieces of data to be processed. The reference value is included in the message stored in the queue 105, and used by the processing time measurement unit 328 to be described below. For example, it takes 0.1 second to delete one message. If the total number of messages is 10000, it takes 1000 seconds (approximately 17 minutes) to delete the entirety of the messages. If the unit time related to the use of the resources is 60 minutes, the reference value calculation unit 304 determines a value calculated by (17×α)/60, as the reference value. α is a buffering factor, which may be a constant such as 1.5. The processing time measurement unit 328 determines whether a value of 0 or more and less than 1, represented by the decimal part of the quotient obtained by dividing the elapsed time after the addition of the processing server 106 managed by the processing time measurement unit 328 by the unit time related to the use of the resources, exceeds the foregoing reference value. For example, suppose that the unit time of the resource occupation time is 60 minutes and the time elapsed after the addition is 65 minutes. The value after the decimal point is 0.08, for 65/60=1.08. If the reference value is 0.5, it is determined that the value does to not exceed the reference value. If the value does not exceed the reference value, the processing server 106 performs processing other than the deletion of the messages from the queue 105 because the resources can be wasted.

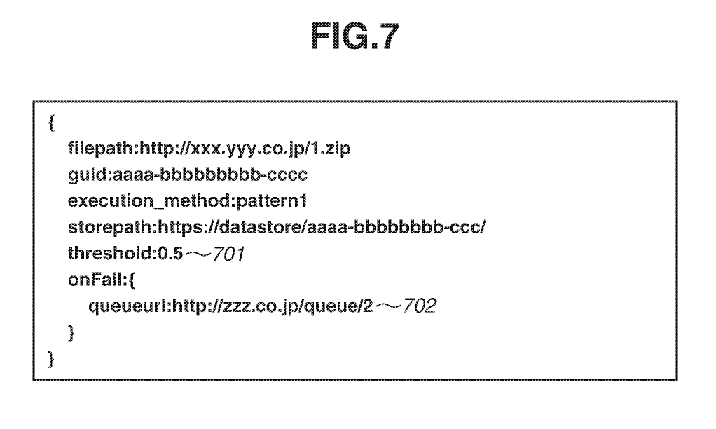

As described above, if a predetermined condition based on the result of comparison between the reference value and a value determined from the elapsed time and the unit time is satisfied, the virtual machines perform different processing. If the processing time determination unit 328 determines that the value is smaller than or equal to the reference value, the message acquisition unit 321 obtains a message from the address of another queue 105 included in the acquired message. An example of the message according to the present exemplary embodiment will be described below with reference to FIG. 7.

The data processing unit 323 is not only capable of specific processing, but is configured to run modules that can perform processing according to processing patterns included in messages obtained from a plurality of queues 105. The data processing unit 323 then performs processing according to information described in the message that is obtained from another queue 105 by the message acquisition 321. After execution of the processing, the data processing unit 323 obtains a message from the original queue 105 again. Whether the reference value is exceeded is then determined based on the elapsed time after the activation, which is managed by the processing time measurement unit 328. Such processing is repeated, and the processing for deleting the messages from the original queue 105 starts to be performed in timing when the reference value is exceeded. In such a manner, the unit time of the resource occupation time can be used as efficiently as possible.

Next, an example of the message stored in the queue 105 according to the present exemplary embodiment will be described with reference to FIG. 7. A reference value 701 and an address 702 of another queue 105 are added to the message described in FIG. 4. The reference value 701 is set to the value determined by the reference value calculation unit 304 as described above. If the processing of any message in a series of messages is found to be failed, the processing server 106 obtains a message from the address 702 of another queue 105. The message obtained from another queue 105 has the same format as described in FIG. 7, and differs only in the set values of items such as the processing pattern 403 and the storepath 404.

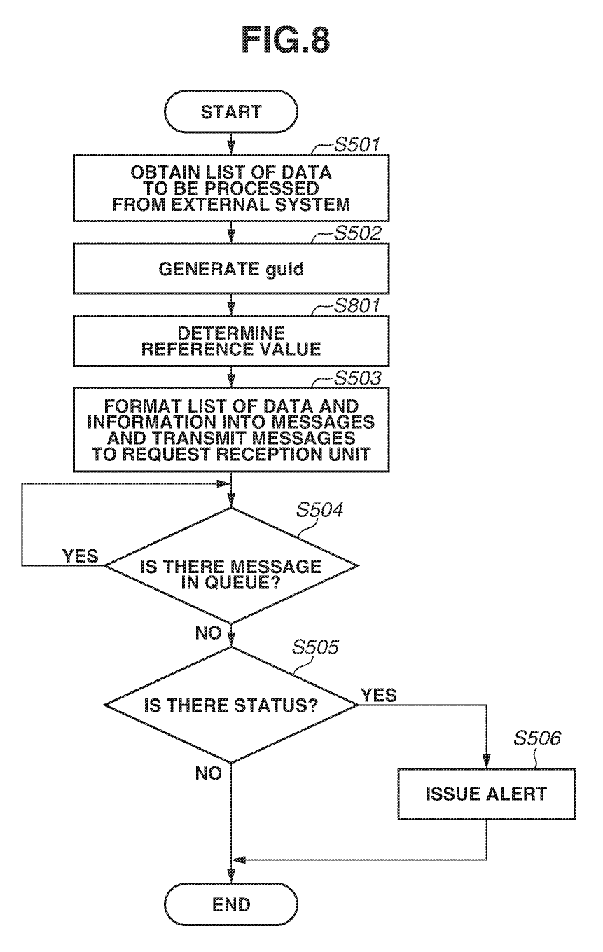

Next, an example of a flow of processing performed by the instruction server 104, including the calculation processing of the reference value, will be described with reference to FIG. 8. As step S801 is added to the flowchart described in FIG. 5, only step S801 will be described.

In step S801, the reference value calculation unit 304 determines the reference value from the number of pieces of data included in the list of data obtained in step S501, the deletion time per message stored in the queue 105, and the unit time related to the use of the resources. The reference value calculation unit 304 writes the determined reference value into the messages. Instead of determining the reference value by calculation, the reference value calculation unit 304 may refer to a table that associates and manages the foregoing reference value with the number of pieces of data, the deletion time per message stored in the queue 105, and the unit time related to the use of the resources.

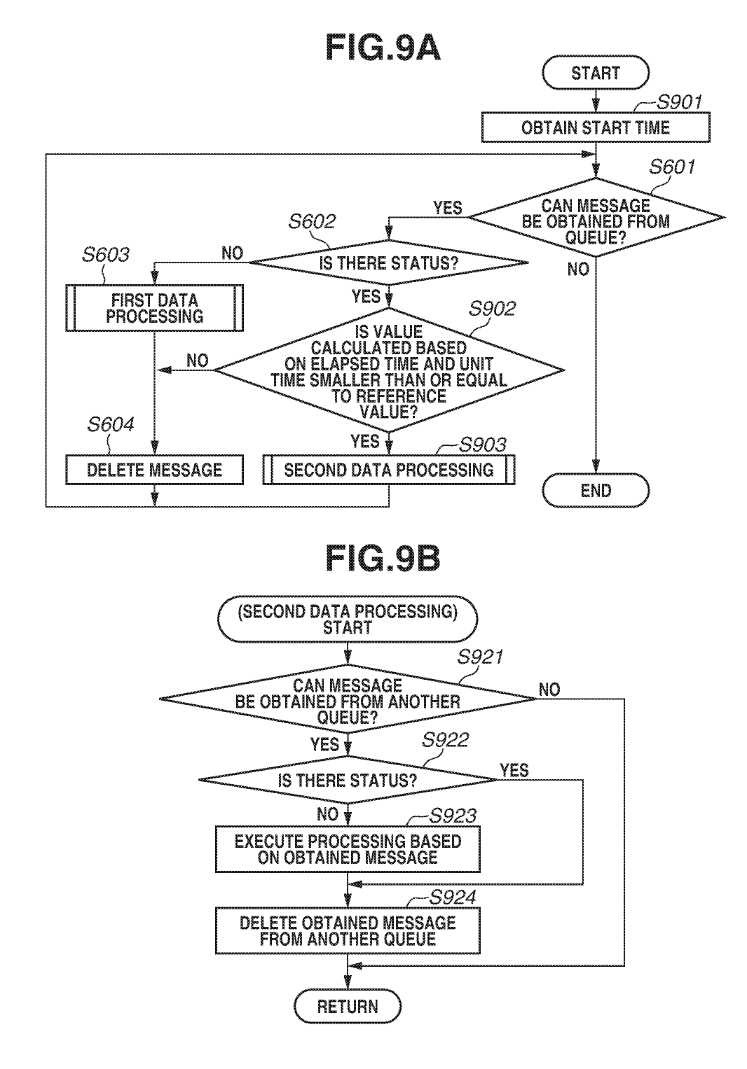

Finally, an example of a flow of processing performed by the processing server 106 will be described with reference to FIGS. 9A and 9B. Such processing is performed by each of one or more processing servers 106 running. Only the steps added in the second exemplary embodiment will be described.

In step S901, the processing time measurement unit 328 obtains a start time of the processing server 106. The processing time measurement unit 328 stores and manages the start time in the processing server 106.

In step S902, the processing time measurement unit 328 determines whether a predetermined condition is satisfied based on the time elapsed since the start time obtained in step S901. The predetermined condition is that the value calculated based on the elapsed time and the unit time is smaller than or equal to the reference value 701 included in the message. If the value is smaller than or equal to the reference value (YES in step S902), the processing proceeds to step S903. In step S903, data processing based on a message of another queue 105 to be described below is performed. If the value is not smaller than or equal to the reference value (NO in step S902), the processing proceeds to step S604. In step S604, the processing for deleting the message is performed as in the first exemplary embodiment.

In step S903, the processing server 106 performs processing of data obtained from another queue 105 (second data processing). The second data processing performed here will be described with reference to FIG. 9B. Another queue 105 refers to any one of one or more queues 105 specified in the message. The queue 105 from which the processing server 106 obtains the message may be determined at random or according to order of priority.

In step S921 of FIG. 9B, the message acquisition unit 321 obtains a message from a queue 105 different from the one from which a message is obtained in step S601. Here, the address 702 of another queue 105 described above with reference to FIG. 7 is used. The message acquisition unit 321 obtains a message from another queue 105 based on the address 702 of another queue 105 included in the message obtained in step S601.

In step S921, if a message can be obtained (YES in step S921), the processing proceeds to step S922. If no message can be obtained (NO in step S921), the processing of the flowchart of FIG. 9B is terminated, and the processing returns to the flowchart of FIG. 9A.

In step S922, the status check unit 327 checks whether a status associated with the identification information of the message obtained from another queue 105 in step S921 is stored in the storage 107.

In step S923, the data processing unit 323 executes the processing based on the message obtained in step S921. In such a manner, the processing server 106 can effectively use the activation time of the processing server 106 by processing a message stored in another queue 105.

In step S924, the message deletion unit 324 issues an instruction to delete the message from the queue from which the message is obtained in step S921.

If YES in step S922, the processing time measurement unit 328 makes the same determination as in step S902. The unit time and the reference value used here are the same as those used in step S902. To determine the elapsed time of the processing server 106 with respect to each queue 105, the processing server 106 records its own start time (step S901) in the storage 107 along with the status indicating a processing error when writing the status.

If the second data processing is performed in step S903, the processing for deleting the message obtained in step S601 is not performed.

The address 702 of another queue 105 may be included in the message obtained by the message acquisition unit 321 but may be stored in the storage 107.

As described above, in the present exemplary embodiment, if the activation time of the processing time 106 satisfies a predetermined condition, the processing server 106 obtains a message from another queue 105 and executes processing based on the obtained message. This enables effective use of the resources and the resulting scale-in described above, which may lead to saving of the use fees of the cloud services.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-244645, filed Dec. 15, 2015, which is hereby incorporated by reference herein in its entirety.

What is claimed is:

1. A system comprising:
one or more virtual machines configured to obtain a message to be processed from a queue storing the message and execute processing based on the obtained message; and
a storage into which a virtual machine is storing data,
wherein the one or more virtual machines each comprising:
an acquisition unit configured to obtain a message from the queue;
an execution unit configured to execute processing of data specified by contents of the obtained message;
a storage unit configured to, if the processing executed by the execution unit is failed, store a status indicating a processing error into the storage in association with identification information of the obtained message; and
an instruction unit configured to issue an instruction to delete the obtained message from the queue,
wherein the instruction unit is configured to, if the status associated with the identification information of the obtained message is stored in the storage, the identification information being included in the obtained message, issue the instruction to delete the message from the queue before completion of the processing regarding the message.

2. The information processing system according to claim 1, wherein the instruction unit is configured to, if the status associated with the identification information of the obtained message is stored in the storage, the identification information being included in the obtained message, issue the instruction to delete the message from the queue without executing the processing regarding the message.

3. The information processing system according to claim 1,
wherein the execution unit is configured to, if the status associated with the identification information of the obtained message is not stored in the storage, the identification information being included in the obtained message, execute the processing of the data specified by the contents of the obtained message, and
wherein the instruction unit is configured to issue the instruction to delete the message from the queue according to the completion of the processing by the execution unit.

4. The information processing system according to claim 1, the virtual machine is added or deleted based on a number of messages stored in the queue.

5. The information processing system according to claim 1, the one or more virtual machines each further comprising a management unit configured to manage time elapsed after the virtual machine is added,
wherein the acquisition unit is configured to, if the status associated with the identification information of the obtained message is stored in the storage, the identification information being included in the obtained message, and a predetermined condition is determined to be satisfied based on the elapsed time, which is managed by the management unit, obtain a message from a different queue included in the information processing system and different from the queue storing the obtained message, and
wherein the execution unit is configured to execute processing based on the message obtained from the different queue.

6. The information processing system according to claim 5,
wherein the management unit further manages a unit time used for charging based on the time elapsed after the virtual machine is added, and a reference value for determining whether the acquisition unit obtains a message from the different queue, and
wherein the predetermined condition is determined to be satisfied when it is determined that the acquisition unit obtains a message from the different queue, based on a result of comparison between the reference value and a value determined from the elapsed time and the unit time.

7. The information processing system according to claim 5, wherein the acquisition unit is configured to, based on information about the different queue specified by the obtained message, obtain the message from the different queue.

8. The information processing system according to claim 5, wherein the instruction unit is configured to, if the status associated with the identification information of the obtained message is stored in the storage, the identification information being included in the message, and the predetermined condition is determined to not be satisfied based on the elapsed time, which is managed by the management unit, issue the instruction to delete the obtained message from the queue storing the message.

9. A method for controlling an information processing system including one or more virtual machines configured to obtain a message to be processed from a queue storing the message and execute processing based on the obtained message, and a storage into which the virtual machine is storing data,
wherein the one or more virtual machines each performs:
obtaining a message from the queue storing a plurality of messages;
executing processing of data specified by contents of the obtained message;
storing, if the executed processing is failed, a status indicating a processing error into the storage in association with identification information of the obtained message; and
issuing an instruction to delete the obtained message from the queue,
wherein, if the status associated with the identification information of the obtained message is stored in the storage, the identification information being included in the message, the instruction to delete the message from the queue is issued before completion of the processing performed in the executing regarding the message.

10. The method according to claim 9, further comprising issuing, if the status associated with the identification information of the obtained message is stored in the storage, the identification information being included in the obtained message, the instruction to delete the message from the queue without executing the processing regarding the message.

11. The method according to claim 9,
wherein the executing, if the status associated with the identification information of the obtained message is not stored in the storing, the identification information being included in the obtained message, the processing of the data specified by the contents of the obtained message, and
wherein the issuing issues the instruction to delete the message from the queue according to the completion of the processing.

12. The method according to claim 9, further comprising adding or deleting based on a number of messages stored in the queue.

13. The method according to claim 9, further comprising managing time elapsed after the virtual machine is added,
wherein the obtaining, if the status associated with the identification information of the obtained message is stored, the identification information being included in the obtained message, and a predetermined condition is determined to be satisfied based on the elapsed time, which is managed by the managing, obtains a message from a different queue and different from the queue storing the obtained message, and
wherein the executing executes processing based on the message obtained from the different queue.

14. The method according to claim 13, further comprising managing a unit time used for charging based on the time elapsed after the virtual machine is added, and a reference value for determining whether the obtaining obtains a message from the different queue, and
wherein the predetermined condition is determined to be satisfied when it is determined that the obtaining obtains a message from the different queue, based on a result of comparison between the reference value and a value determined from the elapsed time and the unit time.

15. The method according to claim 13, wherein the obtaining, based on information about the different queue specified by the obtained message, obtains the message from the different queue.

16. The method according to claim 13, further comprising issuing, if the status associated with the identification information of the obtained message is stored in the storage, the identification information being included in the message, and the predetermined condition is determined to not be satisfied based on the elapsed time, which is managed by the management unit, the instruction to delete the obtained message from the queue storing the message.
